(19) United States
(12) Patent Application Publication
(10) Pub. No.: US 2002/0022503 A1
(43) Pub. Date: Feb. 21, 2002

(54) Mobile phone of dual display and method for displaying data using the same

(76) Inventor: Hae Kyu Lee, Seoul (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 09/796,511

(22) Filed: Mar. 2, 2001

(30) Foreign Application Priority Data
Aug. 16, 2000 (KR) U.M.2000-23153

(51) Int. Cl. H04B 1/38; H04M 1/00

(52) U.S. Cl. 455/566; 455/90; 455/550; 455/575

(57) ABSTRACT

Disclosed is a mobile phone of a dual display and a method for displaying data using the same. The mobile phone includes: an RF terminal for transmitting and receiving RF signal; a main display for displaying operational conditions and messages; a controller connected with the RF terminal for performing a communication and a message displaying; a keypad having keys; a first housing serving as a folder, wherein the main display is mounted on its inner surface; a second housing hinged with the first housing containing the RF terminal and the controller within, wherein the keypad is mounted on an inner surface of the second housing; and a top view display mounted on an upper end surface of the second housing for displaying information of phone state or messages.

### BACKGROUND OF THE INVENTION

1. Field of the Invention

The present invention relates to a mobile phone of a dual display and a method for displaying data using the same, and more particularly, to a mobile phone of a dual display and a method for displaying data using the same, which has an auxiliary display on an upper end of a mobile phone besides a main display mounted on a front surface of the mobile phone, and displays received data using the dual display.

2. Description of the Related Art

In general, a mobile phone includes a body serving to transmit and receive communication signal, a battery for supplying power to the body, an antenna connected to a sending/receiving terminal of the body for sending and receiving wave, and a display of liquid crystal display elements mounted on a side of the body for displaying an operated condition.

The mobile phone takes advantage of a development of technique and users' desire to reduce its size and weight, and functions of the mobile phone are on a diversifying trend. The form of the mobile phone derived during the development of the mobile phone is divided into a stick type and a folder type. The division of the form of the mobile phone is made according to whether or not the folder is attached on a front surface.

Furthermore, the display of the phone is generally mounted on the front upper surface of the phone. The display may be covered with the folder or not. In case of the phone having the display covered with the folder, there is a trouble that a user must unfold the folder to confirm the contents of the display.

Thus, in case of the phone having the display mounted on the front surface of the phone, the display is generally mounted on the upper portion of the front surface and the length of the folder is short not to cover the display with the folder.

However, to manufacture the phone in a small, thin and light form, the length of the display and a keypad of components mounted on the front surface of the phone must be restricted in the length. That is, the larger the display is, the better, because the display provides visual information to the user, and the keypad should not be too small because the user inputs data with the hands.

Moreover, the sending/receiving part of the phone, i.e., a distance between a speaker and a microphone, should not be too short in respect to a distance between the user's ear and mouth. To manufacture the phone of a short length, the speaker is mounted at an end of the folder hinged on the body and the microphone is mounted at an end of the body, and thus the phone can compensate the distance between the user's ear and mouth corresponding to the distance between the speaker and the microphone when the folder is unfolded.

According to the trend of the small, thin and light phone, the length of the phone becomes gradually shorter. However, because the distance between the speaker and the end of the folder must roughly correspond to the distance between the user's ear and mouth, the length of the folder designed to cover the front part of the phone must be similar to the length of the phone.

Therefore, there is an inconvenience that the user must unfold the folder to confirm the contents displayed on the display of the phone. To solve the problem, an auxiliary display is mounted on an external surface of the folder to display simple information, i.e., present time, remaining amount of battery, intensity of wave reception, etc. However, in case of the phone provided with the folder having the main display mounted on an inner surface thereof, the folder is thickened to at least 9 mm or more in comparison with the conventional phone having the folder of about 1˜2 mm in thickness.

The whole thickness of the phone including the thickness of the battery mounted on the rear surface of the body of the phone becomes about 35 mm or more, and thus there is a problem that it is difficult to design the phone as thin as possible.

U.S. Pat. No. 5,946,636 discloses a system for visually displaying categories of incoming call on an auxiliary display besides a main display by sorting incoming cellular calls. The system determines incoming call and displays it on an LCD or LED located on an external surface of the phone into different color codes, so that the user can rapidly recognize categories of incoming call, an identification of the user's own phone and received data information.

However, the system has the limits in displaying various condition information of the phone, kinds of call messages, exact information of a caller since the communication depends on the color codes.

### SUMMARY OF THE INVENTION

It is, therefore, an object of the present invention to provide a mobile phone of a dual display and a method for displaying data using the same, which can conveniently confirm operational information of a phone and received messages without regard to whether or not a folder is opened by mounting an auxiliary display on an upper end of the phone.

To achieve the object, the present invention provides a mobile phone of a dual display including: an RF terminal for transmitting and receiving RF signal through an antenna; a main display for displaying operational conditions and messages; a controller connected with the RF terminal for performing a communication function and a message display function; a keypad connected to the controller and having keys associated for the operation of the mobile phone; a first housing serving as a folder, wherein the main display is mounted on an inner surface of the first housing; a second housing hinged with the first housing at an end thereof and containing the RF terminal and the controller within, wherein the keypad is mounted on an inner surface of the second housing; and a top view display mounted on an upper end surface of the second housing for displaying at least one of information of phone state and messages, wherein the controller displays information of phone state on the top view display in a state that the folder is shut during standing by for incoming call and displays it on the main display in a state that the folder is opened, and if incoming call is received, discriminates kinds of the incoming call and displays at least one of a caller's ID, SMS text receiving sign and message sign, and voice mail receiving sign.

Furthermore, the present invention provides a method for displaying data of a mobile phone having a main display and a top view display, the method including the steps of: ascertaining an opened or shut state of a folder while maintaining a stand by state, and turning off the top view display if the folder is opened, and displaying data on the main display; displaying information of phone state on the top view display if incoming call is not received in a state that the folder is shut; determining whether or not incoming call is any one of speaking call, reception of SMS text, and reception of voice mail, and displaying a kind of the received message; and displaying a message of SMS acknowledge on the top view display if the received incoming call is not speaking call, reception of SMS text, or reception of voice mail.

As described above, the present invention includes an auxiliary display mounted on the upper end surface of the mobile phone besides the main display mounted on the front surface of the mobile phone, thereby conveniently ascertaining information of the phone.

### BRIEF DESCRIPTION OF THE DRAWINGS

Further objects and advantages of the invention can be more fully understood from the following detailed description taken in conjunction with the accompanying drawings in which:

FIG. 1 is a perspective view of a structure of a mobile phone of a dual display, in a state that a folder is shut, according to the present invention;

FIG. 2 is a perspective view of the structure of the mobile phone of the dual display, in a state that the folder is opened, according to the present invention;

FIG. 3 is a side view of the phone, in a state that the folder is folded, according to the present invention;

FIG. 4 is a block diagram of a circuit of the mobile phone according to the present invention;

FIG. 5 is a flow chart for explaining data displaying method using the mobile phone of the dual display according to the invention; and

FIGS. 6 and 7 are views for showing an embodiment displayed on a top view LCD.

### DETAILED DESCRIPTION OF THE PREFERRED EMBODIMENT

The present invention will now be described in detail in connection with preferred embodiments with reference to the accompanying drawings. For reference, like reference characters designate corresponding parts throughout several views.

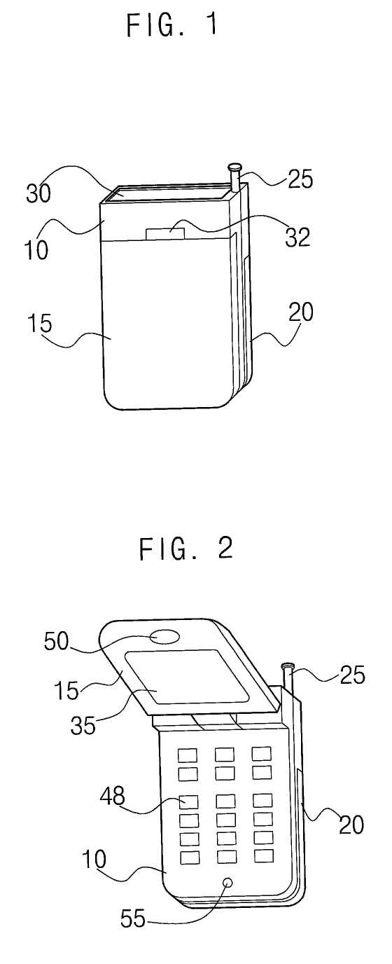

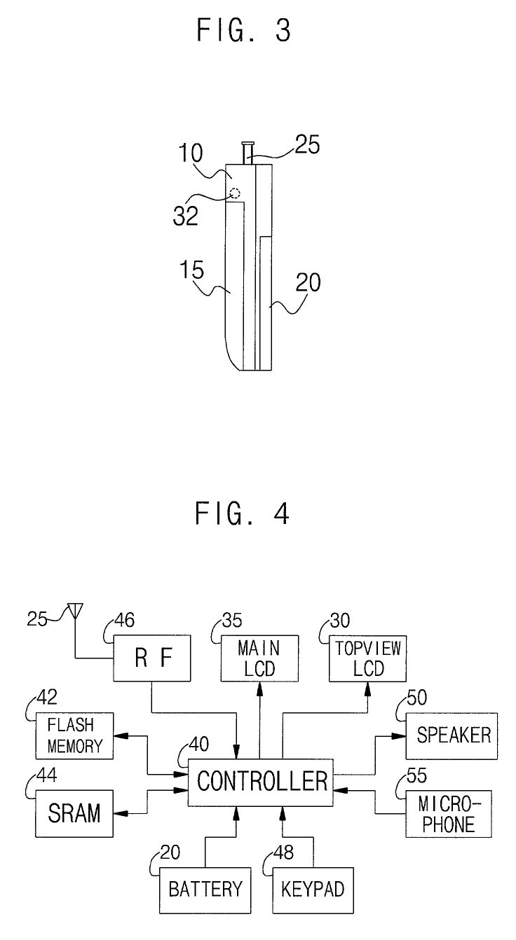

FIG. 1 is a perspective view of a structure of a mobile phone of a dual display, in a state that a folder is shut, according to the present invention. FIG. 2 is a perspective view of the structure of the mobile phone of the dual display, in a state that the folder is opened, according to the present invention. FIG. 3 is a side view of the phone, in a state that the folder is folded, according to the present invention. FIG. 4 is a block diagram of a circuit of the mobile phone according to the present invention.

As shown in FIG. 4, the mobile phone of the dual display according to the present invention includes: an RF terminal 46 for transmitting and receiving RF signal through an antenna 25; a speaker 50 for outputting sound signal; a microphone 55 for inputting sound signal; a battery 20 for supplying power; a main LCD 35 mounted on a front surface of a second housing 10 of the phone for displaying operational conditions, messages, etc.; a top view LCD 30 mounted on an upper end surface of the housing 10 for displaying an intensity of wave reception, remaining amount of battery, time, messages, etc.; a controller 40 connected with the RF terminal 46, the main LCD 35, the top view LCD 30, the speaker 50 and the microphone 55 for controlling to perform a communication function and a message display function; a SRAM 44 for providing a memory area required for the operation of the controller 40; a flash memory 42 for providing a data storing area required for storing messages and an address book; and a keypad 48 connected to the controller 40 and having keys associated for the operation of the mobile phone.

The RF terminal 46, the controller 40, the flash memory 42, the SRAM 44, the keypad 48, the microphone 55, and the top view LCD 30 are received in the second housing 10, which is a body of the phone, and the top view LCD 30 is mounted on an upper end of the second housing 10. The speaker 50 and the main LCD 35 are mounted on a first housing 15, which serves as a folder. The first and second housings 15 and 10 have ends respectively hinged with each other at a hinge part 32 to be opened and shut.

Referring to FIGS. 1 to 3, an external structure of the mobile phone will be described as follows.

As previously described, the second housing 10, i.e., body, contains the RF terminal 46, the controller 40, the flash memory 42, the SRAM 44, the keypad 48, the speaker 50 and the top view LCD 30 therein, and the battery 20 is mounted on a rear surface of the second housing 10. Because the hinge part 32 for hinging the first housing 15 is formed at the upper end of the second housing 10, the first housing 15 can be opened and shut around the hinge part 32. The main LCD 35 and the speaker 50 are mounted on the inner surface of the first housing 15.

Thus, data displayed on the main LCD 35 and the top view LCD 30 has contents varied according to whether or not the mobile phone receives incoming call and the first housing 15, namely the folder 15, is opened.

An element used for the top view LCD 30 is a liquid display element, and its representation way is a dot matrix method and generally displays Korean characters, English characters and number information. The top view LCD 30 can display information synchronized with an edit function of the mobile phone by the user's selection.

Because the top view LCD 30 is located on the upper end surface of the second housing 10, there is a limit in space. However, as shown in FIGS. 2 and 3, when the hinge part 32 of the first housing 15 is located somewhat downwardly, the installation space can be secured. According to circumstances, the hinge part 32 may be somewhat projected to the rear surface of the body 10, on which the battery 20 is mounted.

Furthermore, in the embodiment of the present invention, the top view LCD 30 is mounted on the upper end surface of the second housing, but it will be appreciated that the top view LCD 30 may be mounted on both sides or a lower end surface of the second housing according to circumstances.

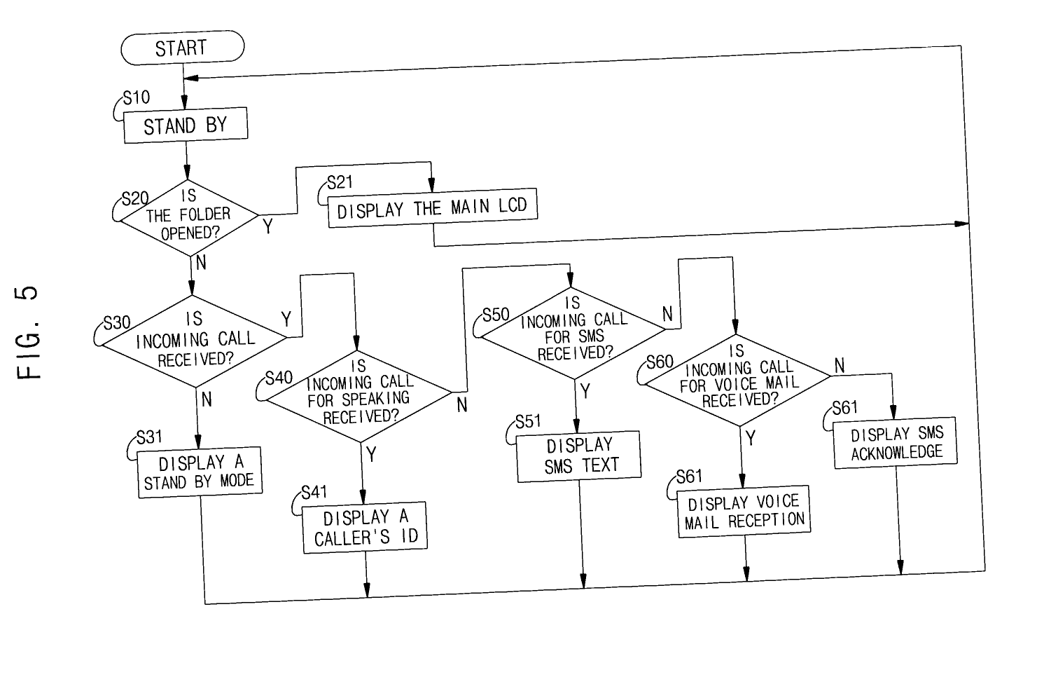

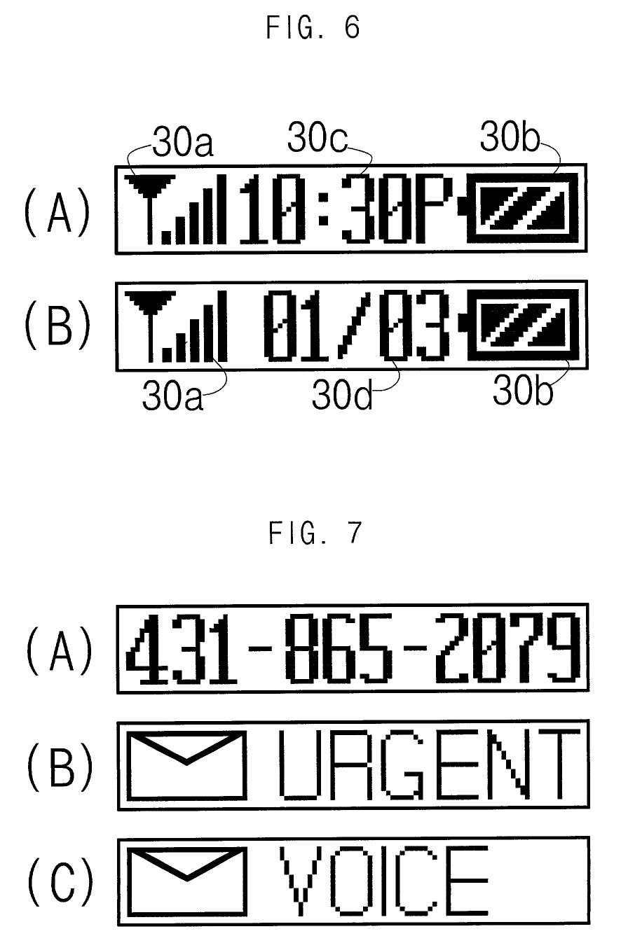

Referring to FIG. 5, a method for displaying data using the mobile phone of the dual display of the present invention will be described hereinafter.

Generally, the mobile phone waits for incoming call in a state that the folder 15 is shut, i.e., in a stand by state (Step S10). In the stand by state, the top view LCD 30 displays information of a reception state of the mobile phone, i.e., the intensity of wave reception, remaining amount of battery and time, and the main LCD 35 maintains an off state.

At this time, as shown in FIG. 4, the top view LCD 30 displays the intensity of wave reception 30a at a left end thereof and the remaining amount of battery 30b at a right end thereof. The top view LCD 30 is too narrow in width to display date and time at the same time, and thus the date and the time are displayed on the top view LCD 30 by turns in a specified period.

If the user opens the first housing 15, namely, the folder, without regard to reception of incoming call (Step S20), information of the intensity of wave reception, the remaining amount of battery and the time and the user's ID, which were displayed on the top view LCD 30, are displayed on the main LCD 35 (Step S21). The top view LCD 30 is turned off, but in the state that the folder is not opened, maintains the stand by mode (Step S31) like the above stand by step (Step S10). That is, the top view LCD 30 displays the intensity of wave reception 30a, the time 30c, the date 30d and the remaining amount of battery 30b, in the state that the main LCD 35 is turned off (Step S31).

However, when incoming call for speaking is received (Step S40), the caller's ID (the caller's telephone number) is displayed on the top view LCD 30 as shown in FIG. 7(A) (Step S41).

If the incoming call is not incoming call for speaking (Step S40) but incoming call for receiving SMS (Short Message Service) text (Step S50), an icon informing the reception of the SMS text is displayed on the top view LCD 30 (Step 51) (See FIG. 7(B)).

If the incoming call is not incoming call for receiving SMS text (Step 50) but incoming call for voice mail (Step S60), an icon informing the reception of the voice mail is displayed on the top view LCD 30 (See FIG. 7(c)).

If the incoming call is not incoming call for voice mail (Step S60), SMS acknowledge is displayed on the top view LCD 30 (Step S62).

In the SMS text receiving step (Step S50 and S51) if the user presses a message button to ascertain the SMS text, the SMS text is displayed on the top view LCD 30.

If the length of SMS text exceeds a range for displaying text of the top view LCD 30, the contents of the text is displayed while being scrolled in a specified period of time. If the user presses the message button to ascertain the voice mail, the received voice mail is output through the speaker 50.

As described above, according to the present invention, because the top view display is mounted on the upper end surface of the phone, the user can promptly and conveniently ascertain the party's telephone number before answering the phone if using a caller's phone number indicating service. Moreover, in case of the user carrying the phone using a necklace, the user conveniently ascertain information of the phone by bowing his/her head without touching it with the hand.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A mobile phone of a dual display comprising:
an RF terminal for transmitting and receiving RF signal through an antenna;
a main display for displaying operational conditions and messages;
a controller connected with the RF terminal for performing a communication function and a message display function;
a keypad connected to the controller and having keys associated for the operation of the mobile phone;
a first housing serving as a folder, wherein the main display is mounted on an inner surface of the first housing;
a second housing hinged with the first housing at an end thereof and containing the RF terminal and the controller within, wherein the keypad is mounted on an inner surface of the second housing; and
a top view display mounted on an upper end surface of the second housing for displaying at least one of information of phone state and messages,
wherein the controller displays information of phone state on the top view display in a state that the folder is shut during standing by for incoming call and displays it on the main display in a state that the folder is opened, and if incoming call is received, discriminates kinds of the incoming call and displays at least one of a caller's ID, SMS text receiving sign and message sign, and voice mail receiving sign.

2. The mobile phone as claimed in claim 1, wherein the top view display has liquid crystal display elements.

3. The mobile phone as claimed in claim 1, wherein information of phone state contains information of intensity of wave reception, remaining amount of battery, time and date.

4. The mobile phone as claimed in claim 1, wherein information displayed on the top view display is synchronized with information displayed on the main display.

5. The mobile phone as claimed in claim 1, wherein information displayed on the top view display selectively shows kinds of information displayed using a displayed information editing function of the mobile phone.

6. A method for displaying data of a mobile phone having a main display and a top view display, the method comprising the steps of:
ascertaining an opened or shut state of a folder while maintaining a stand by state, and turning off the top view display if the folder is opened, and displaying data on the main display;
displaying information of phone state on the top view display if incoming call is not received in a state that the folder is shut;
determining whether or not incoming call is any one of speaking call, reception of SMS text, and reception of voice mail, and displaying a kind of the received message; and
displaying a message of SMS acknowledge on the top view display if the received incoming call is not speaking call, reception of SMS text, or reception of voice mail.

7. The method as claimed in claim 6, wherein information of phone state contains information of intensity of wave reception, remaining amount of battery, time and date.

8. The method as claimed in claim 6, wherein the message displaying step includes the steps of:
displaying a caller's ID on the top view display if the incoming call is the speaking call;
displaying the SMS text on the top view display if the incoming call is the SMS text; and
displaying a message informing of the reception of voice mail if the incoming call is the voice mail.

9. The method as claimed in claim 6, wherein the SMS text reception displaying step includes the steps of:
displaying received message on the top view display if a user presses a message button; and
scrolling and displaying the contents of message in a specified period of time, if the length of the displayed message exceeds a range for displaying text of the top view display.
